(19) United States
(12) Patent Application Publication
(10) Pub. No.: US 2011/0177322 A1
(43) Pub. Date: Jul. 21, 2011

(54) Ceramic articles and methods

(76) Inventors: Douglas Charles Ogrin, Alvin, TX (US); Kyle Ryan Kissell, Marvel, TX (US); Joshua Charles Falkner, Richmond, TX (US); Kurt Lee Lundberg, Kingwood, TX (US); John Richard Tidrow, Houston, TX (US)

(21) Appl. No.: 12/657,244

(22) Filed: Jan. 16, 2010

(51) Int. Cl. B32B 18/00; C04B 35/64

(52) U.S. Cl. 428/325; 264/645; 977/902

(57) ABSTRACT

Method for making a ceramic article and an article made by such a method; the method including mixing ceramic material and nanotubes, and processing the mixture so that nanotubes become transformed material. This abstract is provided to comply with the rules requiring an abstract which will allow a searcher or other reader to quickly ascertain the subject matter of the technical disclosure and is submitted with the understanding that it will not be used to interpret or limit the scope or meaning of the claims, 37 C.F.R. 1.72(b).

### BACKGROUND OF THE INVENTION

1. Field of the Invention

The present invention is directed to ceramic articles with processed carbon nanotubes (in one aspect, transformed nanotubes or graphene nanoribbons resulting from subjecting nanotubes to pressure and/or temperature) and to methods for making such articles.

2. Description of Related Art

There is a wide variety of known ceramic articles and methods for making them. There are known ceramic articles containing carbon nanotubes and methods for making them.

Prior patents and applications disclose a variety of carbon nanotubes, ceramic articles, ceramic articles containing carbon nanotubes, films, coatings and methods for making them; including, but not limited to, those in exemplary U.S. Patents and applications: U.S. Pat. Nos. 7,581,645; 7,578,939; 7,442,414; 7,041,372; 6,911,260; 6,826,996; 6,858,173; 6,420,293; 5,824,940; 5,618,875; 5,424,054; U.S. Ser. Nos. 12/189,684 filed 11 Aug. 2008; Ser. No. 12/025,626 filed 4 Feb. 2008; Ser. No. 11/924,948 filed 26 Oct. 2007; Ser. No. 11/656,603 filed 23 Jan. 2007; Ser. No. 11/579,750 filed 31 May 2005; Ser. No. 11/450,221 filed 9 Jun. 2006; Ser. No. 11/090,259 filed 25 Mar. 2005; Ser. No. 10/984,619 filed 9 Nov. 2004; Ser. No. 10/859,346 filed 3 Jun. 2004; Ser. No. 10/759,356 filed 16 Jan. 2004; and Ser. No. 10/366,183 filed 13 Feb. 2003 (all incorporated fully herein for all purposes).

Graphite layers, graphene ribbons, and articles with them are well known. Exemplary patents and applications which disclose them include, but are not limited to, U.S. Pat. Nos. 7,550,129; 7,510,762; 7,396,494; 7,015,142; and 6,537,515; and U.S. application Ser. No. 12/243,165 filed 10 Oct. 2008 (which is not an exhaustive list; and all said patents and applications incorporated fully herein for all purposes).

Ceramic articles with carbon nanotubes are discussed in many publications, including, but not limited to, in “Carbon Nanotube Reinforced Ceramic Matrix Composites—A Review,” Journal of Minerals & Materials Characterization & Engineering, Volume 7, Number 4, 2008, pp. 355-370. Graphene is discussed generally in many publications, including, but not limited to, in “Graphene: Carbon As Thin As Can Be,” Chemical & Engineering News, Volume 87, Number 9, Mar. 2, 2009, pp. 14-20.

There has long been a need, recognized by the present inventors, for a durable, impact resistant low weight ceramic article with carbon nanomaterial and efficient methods for making such an article.

### SUMMARY OF THE PRESENT INVENTION

The present invention, in certain aspects, discloses a ceramic article with a matrix of ceramic material and transformed materials (e.g. pieces of nanotubes and/or of graphene nanoribbons resulting from subjecting nanotubes to pressure and temperature). In one aspect, the ceramic material is alumina oxide. In one aspect, transformed materials, (e.g. graphene ribbon-like material, “ribbons”), in the finished article are produced by crushing carbon nanotubes in a mixture of ceramic material. In certain aspects the nanotubes prior to transformation are single-walled nanotubes, double walled nanotubes, and/or surface modified nanotubes, or multi-walled nanotubes.

In one aspect, in a method according to the present invention, a matrix of ceramic material and transformed materials, e.g. graphene ribbons, is subjected to temperature and pressure. In one aspect, an alumina matrix with transformed material (e.g. ribbons) therein is subjected to temperature and pressure. In one aspect the present invention discloses a method for making a ceramic article, the method including: processing ceramic material producing processed ceramic material; pocessing carbon nanotube material producing processed nanotube material; combining the processed ceramic material and the processed nanotube material forming a first mixture; subjecting the first mixture to pressure converting the processed nanotube material to transformed material and heating the first mixture producing a processed article; and cooling the processed article, producing a finished ceramic article.

In certain aspects, a ceramic article according to the present invention is made using a mold with a particular shape. The mold may be any desired shape to produce a ceramic article of a desired shape (e.g., but not limited to, shapes as in the drawing figures herein).

In certain aspects, a finished ceramic article according to the present invention with ceramic material and transformed materials (e.g. graphene ribbons) also contains one or more of: single-walled nanotubes; double-walled nanotubes; multi-walled nanotubes; surface modified nanotubes, and/or graphene ribbons not produced by subjection to pressure and temperature during making of a ceramic article.

Filed on even date herewith, co-owned with the present invention, and incorporated fully herein for all purposes is U.S. Patent Application Serial Number entitled “Armor With Transformed Nanotube Material.” Filed on even date herewith, co-owned with the present invention, and incorporated fully herein for all purposes is U.S. Patent Application Serial Number entitled “Metallized Nanotubes.”

Accordingly, the present invention includes features and advantages which are believed to enable it to advance ceramic nanotechnology. Characteristics and advantages of the present invention described above and additional features and benefits will be readily apparent to those skilled in the art upon consideration of the following description of preferred embodiments and referring to the accompanying drawings.

Certain embodiments of this invention are not limited to any particular individual feature disclosed here, but include combinations of them distinguished from the prior art in their structures, functions, and/or results achieved. Features of the invention have been broadly described so that the detailed descriptions of embodiments preferred at the time of filing for this patent that follow may be better understood, and in order that the contributions of this invention to the arts may be better appreciated. There are, of course, additional aspects of the invention described below and which may be included in the subject matter of the claims to this invention. Those skilled in the art who have the benefit of this invention, its teachings, and suggestions will appreciate that the conceptions of this disclosure may be used as a creative basis for designing other structures, methods and systems for carrying out and practicing the present invention. The claims of this invention are to be read to include any legally equivalent devices or methods which do not depart from the spirit and scope of the present invention.

What follows are some of, but not all, the objects of this invention. In addition to the specific objects stated below for at least certain embodiments of the invention, other objects and purposes will be readily apparent to one of skill in this art who has the benefit of this invention's teachings and disclosures. It is, therefore, an object of at least certain embodiments of the present invention to provide the embodiments and aspects listed above and:

New, useful, unique, efficient, nonobvious ceramic articles with transformed materials, e.g. pieces of nanotubes subjected to pressure and temperature, and/or graphene ribbon-like material.

New, useful, unique, efficient, nonobvious methods for making ceramic articles with transformed materials, e.g. pieces of nanotubes subjected to pressure and temperature, and/or graphene ribbon-like material; and

Such methods that include the production of transformed materials, e.g., but not limited to, graphene ribbon-like material from carbon nanotubes during the making of a ceramic article.

The present invention recognizes and addresses the problems and needs in this area and provides a solution to those problems and a satisfactory meeting of those needs in its various possible embodiments and equivalents thereof. To one of skill in this art who has the benefits of this invention's realizations, teachings, disclosures, and suggestions, various purposes and advantages will be appreciated from the following description of certain preferred embodiments, given for the purpose of disclosure, when taken in conjunction with the accompanying drawings. The detail in these descriptions is not intended to thwart this patent's object to claim this invention no matter how others may later attempt to disguise it by variations in form, changes, or additions of further improvements.

The Abstract that is part hereof is to enable the U.S. Patent and Trademark Office and the public generally, and scientists, engineers, researchers, and practitioners in the art who are not familiar with patent terms or legal terms of phraseology to determine quickly, from a cursory inspection or review. the nature and general area of the disclosure of this invention. The Abstract is neither intended to define the invention, which is done by the claims, nor is it intended to be limiting of the scope of the invention or of the claims in any way.

It will be understood that the various embodiments of the present invention may include one, some, or all of the disclosed, described, and/or enumerated improvements and/or technical advantages and/or elements in claims to this invention.

Certain aspects, certain embodiments, and certain preferable features of the invention are set out herein. Any combination of aspects or features shown in any aspect or embodiment can be used except where such aspects or features are mutually exclusive.

### BRIEF DESCRIPTION OF THE SEVERAL VIEWS OF THE DRAWINGS

A more particular description of embodiments of the invention briefly summarized above may be had by references to the embodiments which are shown in the drawings which form a part of this specification. These drawings illustrate embodiments preferred at the time of filing for this patent and are not to be used to improperly limit the scope of the invention which may have other equally effective or legally equivalent embodiments.

FIG. 1 is a schematic view of a method according to the present invention.

FIG. 2A is a perspective view of a tile according to the present invention.

FIG. 2B is a perspective view of a disc according to the present invention.

FIG. 2C is a perspective view of a panel according to the present invention.

FIG. 2D is a perspective view of a cylinder according to the present invention.

FIG. 2E is a perspective view of a pyramid according to the present invention.

FIG. 2F is a perspective view of a sphere according to the present invention.

FIG. 2G is a perspective view of a cone according to the present invention.

FIG. 2H is a side view of a knife according to the present invention.

FIG. 2I is a side view of a key according to the present invention.

FIG. 2J is a side view of a gear according to the present invention.

FIG. 2K is a side view of a hook according to the present invention.

FIG. 2L is a side view of a nut-bolt combination according to the present invention.

FIG. 2M is a side view of a chain according to the present invention.

FIG. 2N is a top view of a chain according to the present invention.

FIG. 2O is a side view of a screw according to the present invention.

FIG. 2P is a side view of a scalpel according to the present invention.

FIG. 2Q is a cross-section view of a bearing structure according to the present invention.

FIG. 2R is a side view of a drill bit according to the present invention.

FIG. 2S is a side view of a mill according to the present invention.

FIG. 2T is a side view of a reamer according to the present invention.

FIG. 2U is a perspective view of a pipe according to the present invention.

FIG. 2V is a side view of a universal joint according to the present invention.

FIG. 2W is a side view partially in cross-section of a drill bit according to the present invention.

FIG. 2X is a perspective view of a drill bit according to the present invention.

FIG. 2Y is a side view of pliers according to the present invention.

FIG. 2Za is a top view of a sluice according to the present invention.

FIG. 2Zb is a cross-section view of the sluice of FIG. 2Za.

FIG. 2AA is a top view of a wear plate according to the present invention.

FIG. 2BB is a side view of the wear plate of FIG. 2AA.

FIG. 2CC is a cross-section view of a conveyor wear plate according to the present invention.

FIG. 2DD is a perspective view of a pump wear plate according to the present invention.

FIG. 2EE is a side view of a pump impeller according to the present invention.

FIG. 2FF is a side cross-section view of a centrifuge according to the present invention.

FIG. 2GG is a perspective view of part of the centrifuge of FIG. 2FF.

FIG. 2HH is an enlarged view of part of the centrifuge of FIG. 2FF.

FIG. 2II shows a ball valve according to the present invention.

FIG. 2 JJ is a cutaway view of the valve of FIG. 2II.

FIG. 2KK is a perspective, partially cutaway view of a valve according to the present invention.

FIG. 3A is a scanning electron micrograph of an article according to the present invention at 1,000× magnification.

FIG. 3B is an enlarged view of part of the scanning electron micrograph of FIG. 3A at 5,000× magnification.

FIG. 3C is an enlarged view of part of the scanning electron micrograph of FIG. 3A at 10,000× magnification.

FIG. 3D is an enlarged view of part of the scanning electron micrograph of FIG. 3A at 10,000× magnification.

FIG. 3E is an enlarged view of part of the scanning electron micrograph of FIG. 3A at 20,000× magnification.

FIG. 3F is an enlarged view of part of the scanning electron micrograph of FIG. 3A at 50,000× magnification.

FIG. 3G is a scanning electron micrograph of a matrix according to the present invention at 10,000× magnification.

FIG. 3H is an enlargement of part of the scanning electron micrograph of FIG. 3G at 50,000× magnification.

Certain embodiments of the invention are shown in the above-identified figures and described in detail below. Various aspects and features of embodiments of the invention are described below and some are set out in the dependent claims. Any combination of aspects and/or features described below or shown in the dependent claims can be used except where such aspects and/or features are mutually exclusive. It should be understood that the appended drawings and description herein are of certain embodiments and are not intended to limit the invention or the appended claims. On the contrary, the intention is to cover all modifications, equivalents and alternatives falling within the spirit and scope of the invention as defined by the appended claims. In showing and describing these embodiments, like or identical reference numerals are used to identify common or similar elements. The figures are not necessarily to scale and certain features and certain views of the figures may be shown exaggerated in scale or in schematic in the interest of clarity and conciseness.

As used herein and throughout all the various portions (and headings) of this patent, the terms “invention”, “present invention” and variations thereof mean one or more embodiments, and are not intended to mean the claimed invention of any particular appended claim(s) or all of the appended claims. Accordingly, the subject or topic of each such reference is not automatically or necessarily part of, or required by, any particular claim(s) merely because of such reference. So long as they are not mutually exclusive or contradictory any aspect or feature or combination of aspects or features of any embodiment disclosed herein may be used in any other embodiment disclosed herein. The drawing figures present the embodiments preferred at the time of filing for this patent.

### DETAILED DESCRIPTION OF THE INVENTION

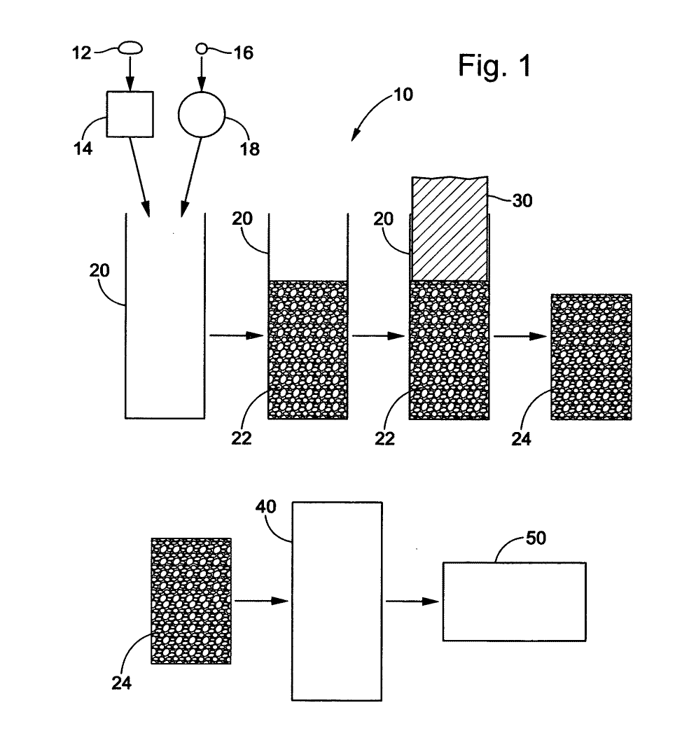

FIG. 1 illustrates schematically a method 10 according to the present invention. Ceramic material 12 is processed in a processing apparatus 14 and then processed ceramic material is introduced into a mold 20. In one aspect the processing apparatus 14 produces ceramic material within a desired size (largest dimension) range, e.g. between 10 nanometers and 100 microns. In one particular aspect, the ceramic material is aluminum oxide (alumina) particles and the processing apparatus 14 is a dry ball mill which mills or grinds the particles to a median size (largest dimension) of about 700 nanometers (in one aspect within a range of between 650 nanometers and 750 nanometers); and, in one aspect, with the milled particles having a surface area between 3.5 to 4.5 square meters per gram.

Carbon nanotube material 16 is processed by a processing method 18 and then processed nanotube material is introduced into the mold 20. In one aspect, the carbon nanotube material is multi-walled nanotubes. In other aspects, it is any desired nanotube material. In one aspect of a method 18, the nanotubes are suspended in ethanol in a bath and sonicated using any suitable known sonication method to achieve deagglomeration of bundles of nanotubes, to create a metastable nanotube suspension, and to wet the nanotube surfaces with ethanol. In one aspect, the suspension is sonicated for about thirty minutes. In one particular aspect, a two-vessel sonication method is used with transducers and wave transfer liquid. The resulting nanotube-ethanol mixture is added to an aluminum oxide-ethanol mixture and the resulting mixture is sonicated.

The resulting sonicated mixture is then stirred to produce a more homogeneous mixture, e.g. for about one hour. The stirred mixture is poured into a container so that the ethanol in the mixture evaporates, e.g. the container is a baking dish and the mixture is allowed to sit overnight, e.g. about eight to ten hours, for ethanol evaporation. The resulting dried material is then baked (to insure all water and ethanol are removed, e.g. at about eighty degrees centigrade in a vacuum oven for two to three hours. The resulting material is then milled in a ball mill e.g. to within a size range of between ten nanometers and one hundred microns. Then milled material is introduced into the mold 20 producing a ceramic-material/nanotube mixture 22 in the mold 20.

In one aspect, the alumina and multi-walled nanotube material in the mold is between 0.1% to 10% by weight nanotubes, the remainder alumina. In one particular aspect, the material in the mold is between 0.1% to 1.0% by weight nanotubes.

A compression member 30 is applied to the mixture 22 in the mold at a pressure sufficient to achieve crushing of the nanotubes producing graphene ribbon-like material (“ribbons”) in the mixture; e.g. in one aspect, pressure applied at between 10,000 psi and 100,000 psi. In one particular aspect, about the actual applied pressure was about 50,000 psi. A compressed mixture 24 is produced.

The compressed mixture 24 is sintered in a furnace 40 producing a ceramic article 50. In one particular aspect in which the ceramic material is the alumina described above and the nanotubes are the multi-walled carbon nanotubes described above, the mixture 24 is sintered at 1600 degrees C. for between 0.5 hour to 24 hours in an inert oxygen-free (e.g., argon, nitrogen) atmosphere or in a vacuum. The article is cooled in or out of an oven or furnace, using any suitable method and/or apparatus. In one aspect cooling is enhanced by flowing cold inert gas through the oven or furnace. In another aspect, the article is removed from an oven or furnace and transferred to a secondary cooling chamber and, in one particular aspect, during such movement an inert atmosphere is maintained around the article.

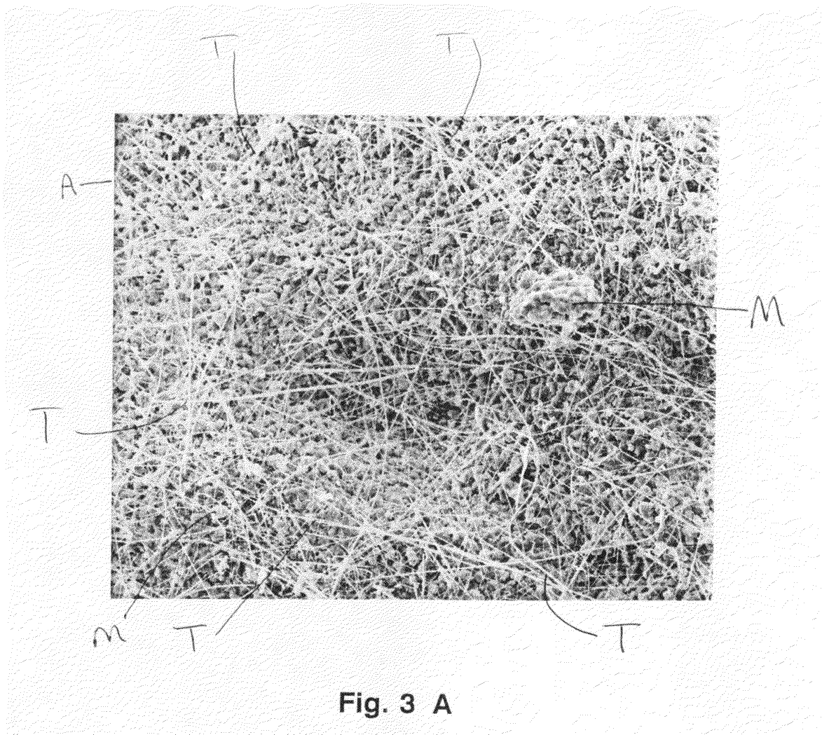

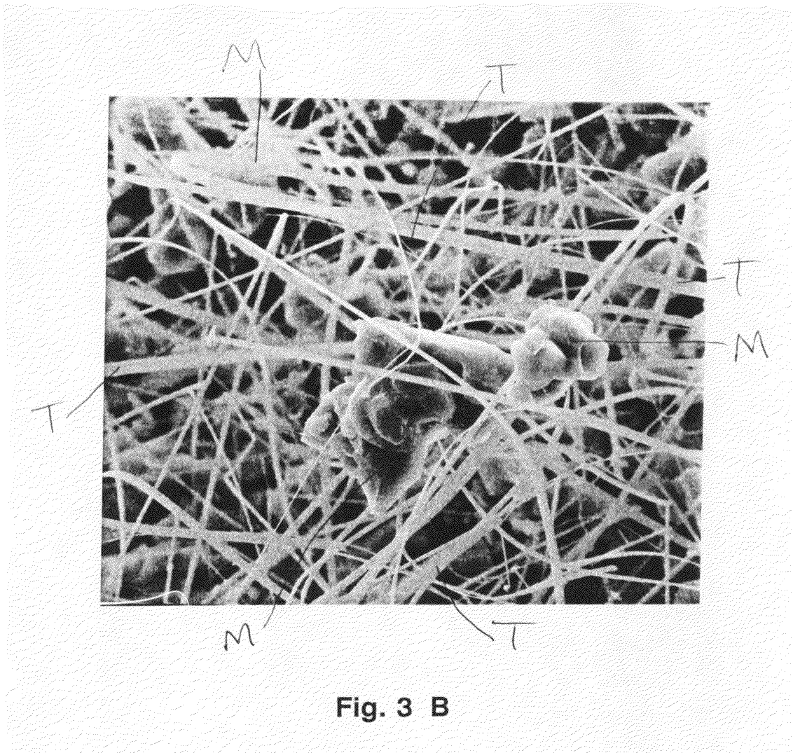

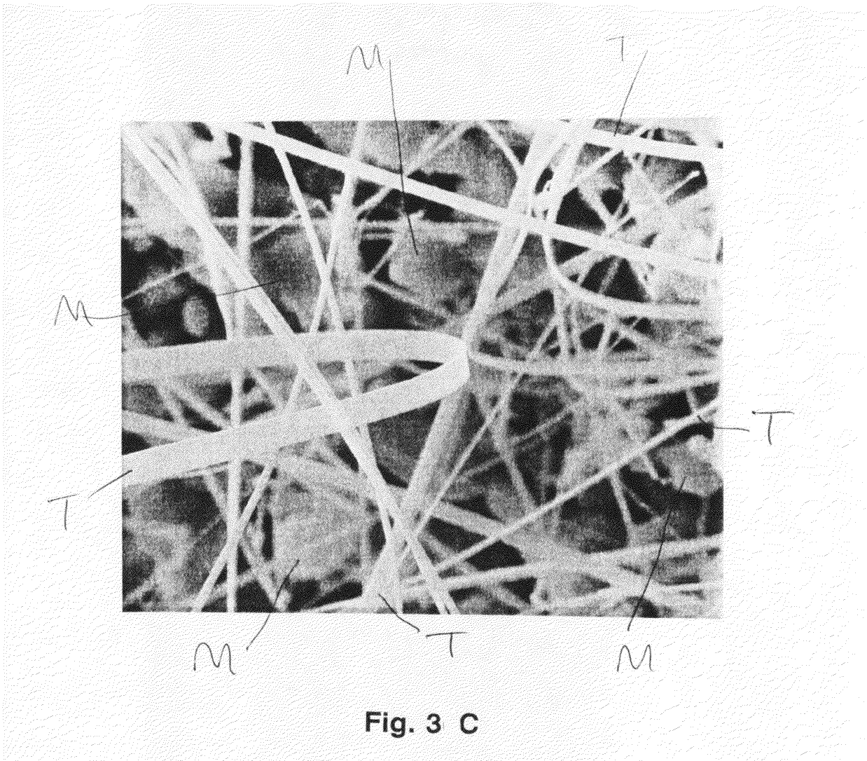

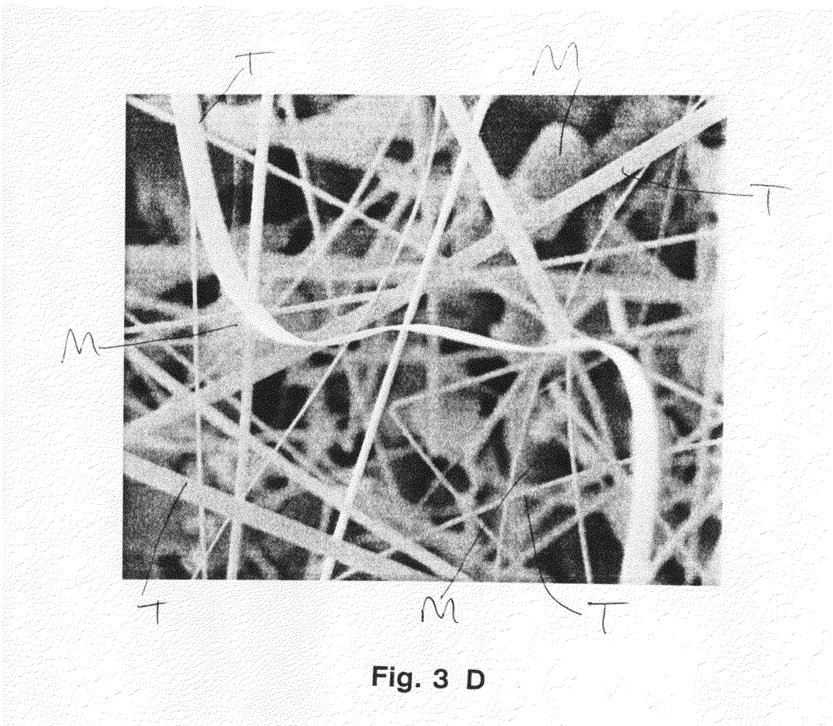

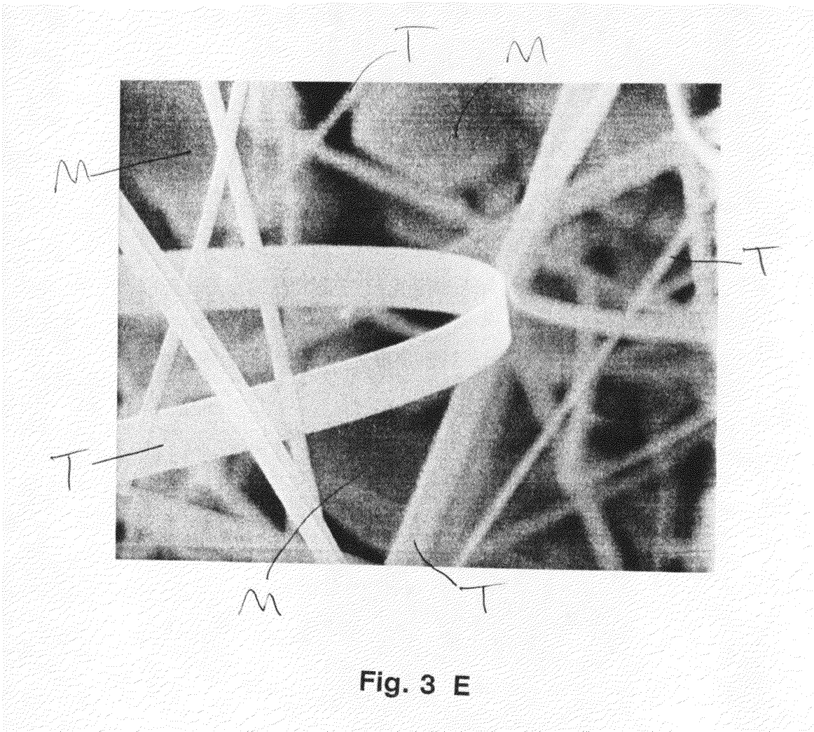

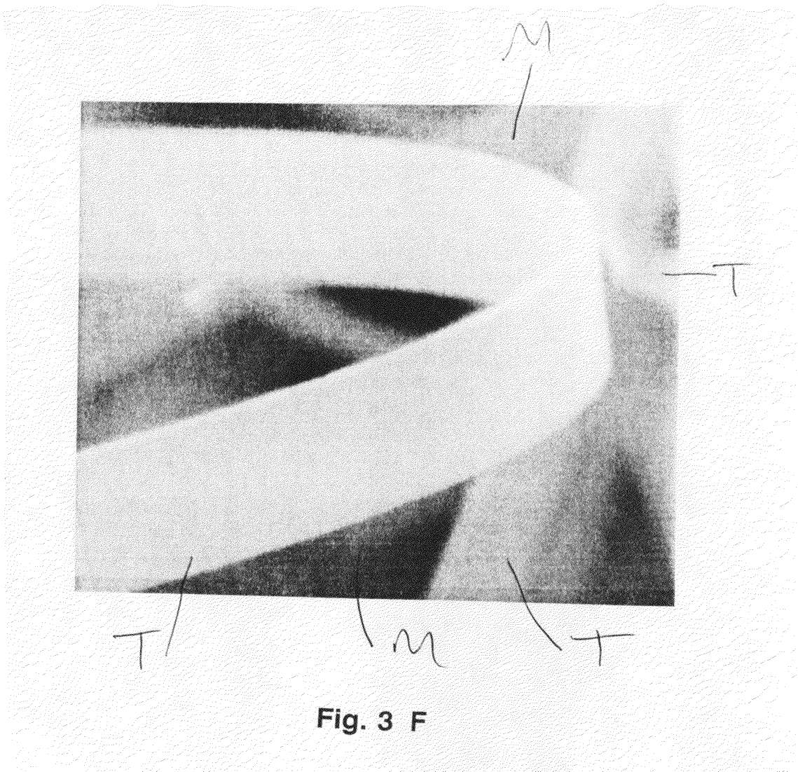

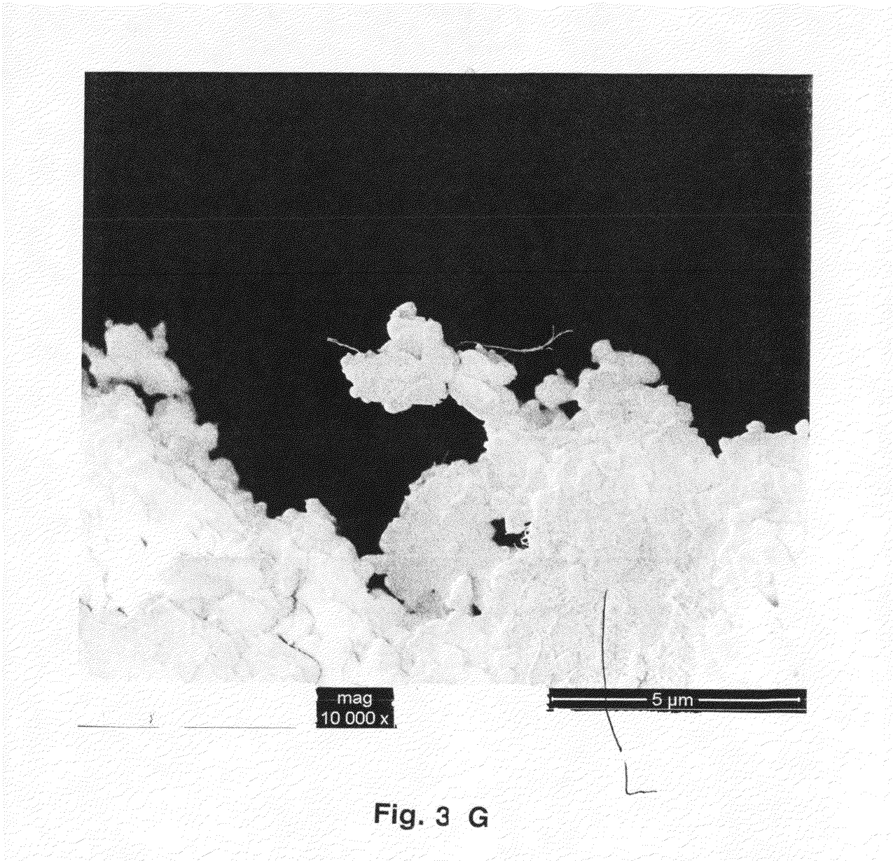

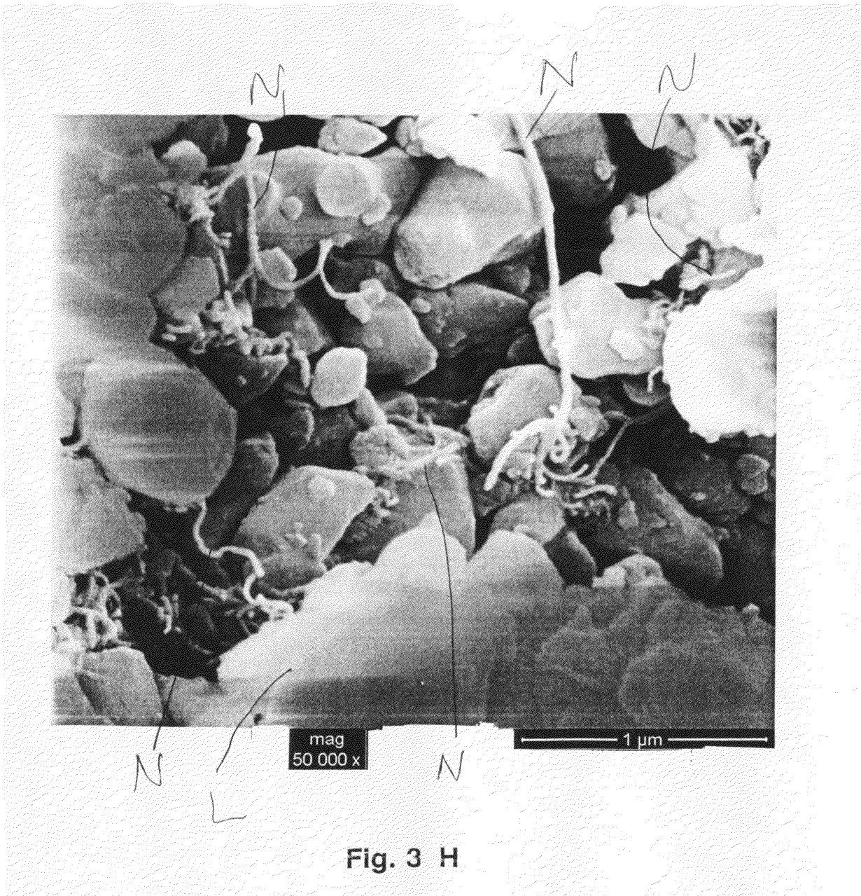

As shown, e.g., in FIG. 3A, a finished article according to the present invention made by a method according to the present invention, e.g. as described above, has transformed material uniformly distributed throughout the article.

Prior to solvent evaporation and pressing and/or prior to sintering, additional nanotube material and/or transformed materials and/or graphene ribbon material may be added to a matrix according to the present invention.

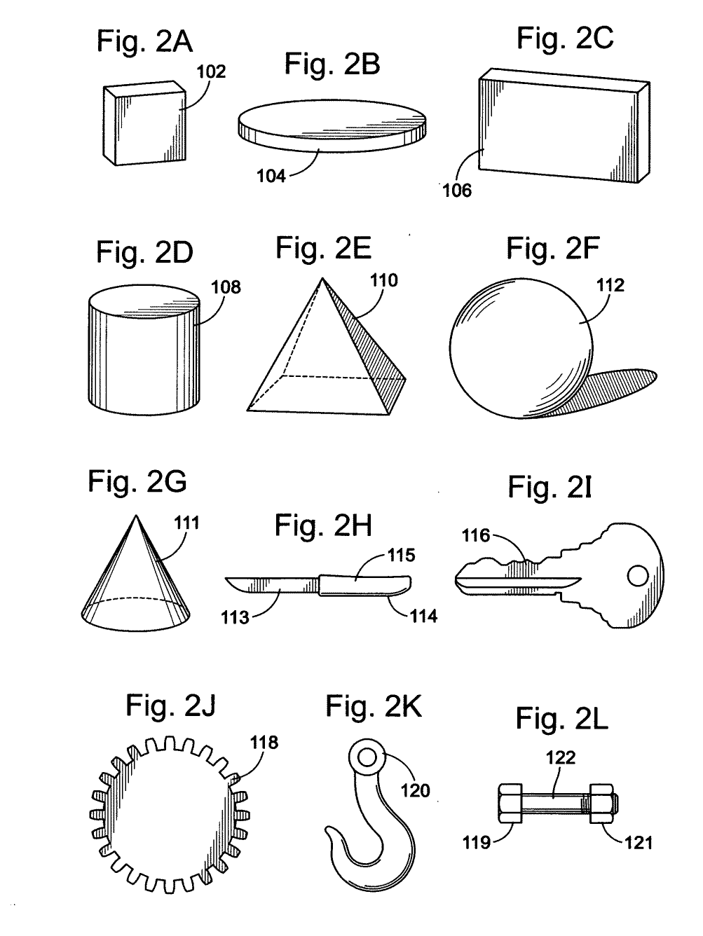

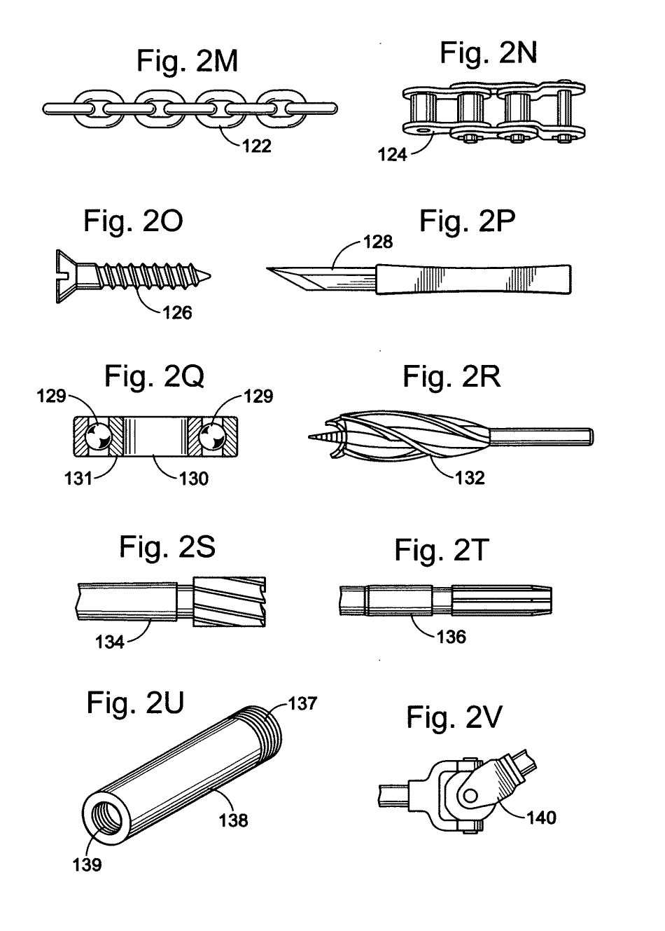

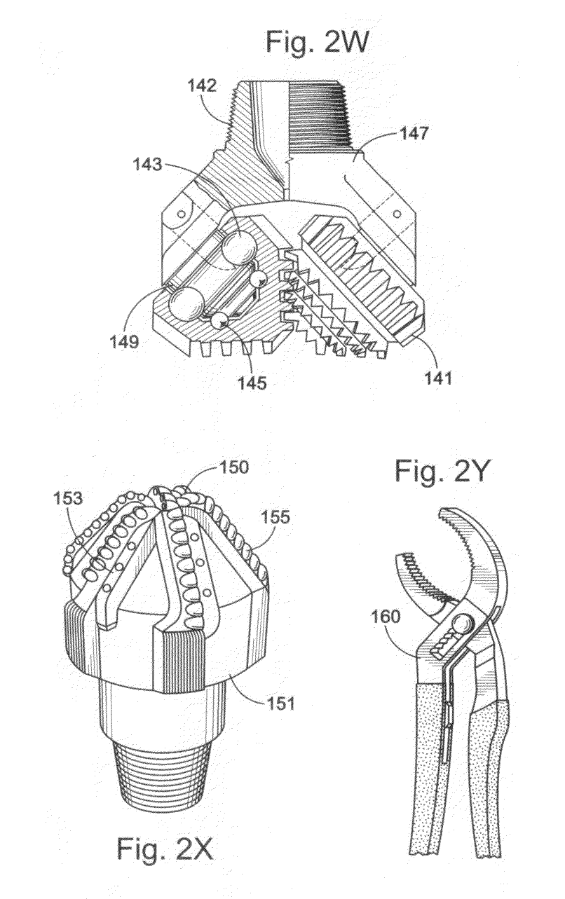

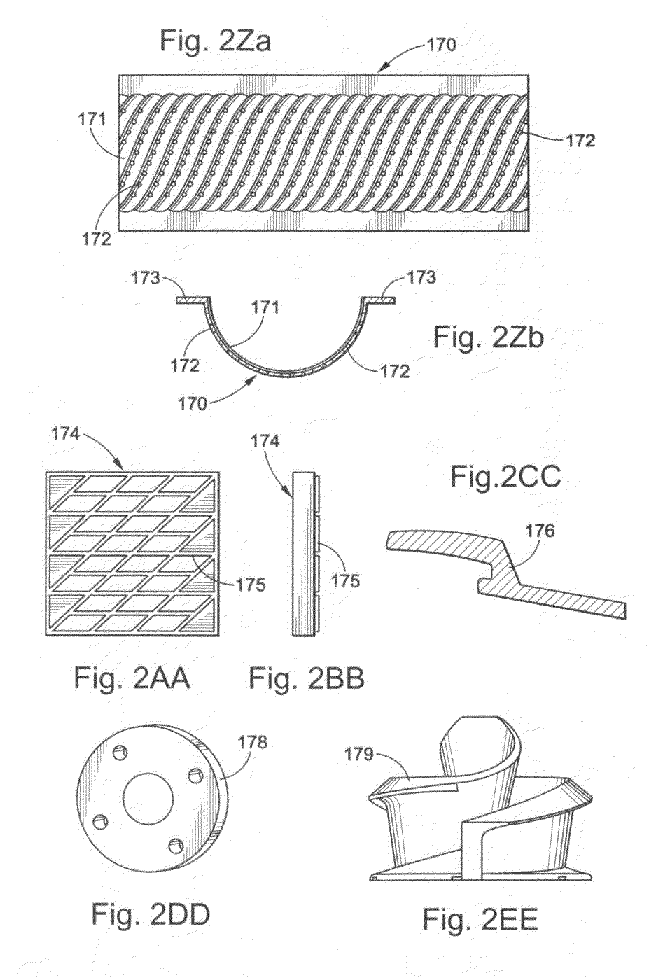

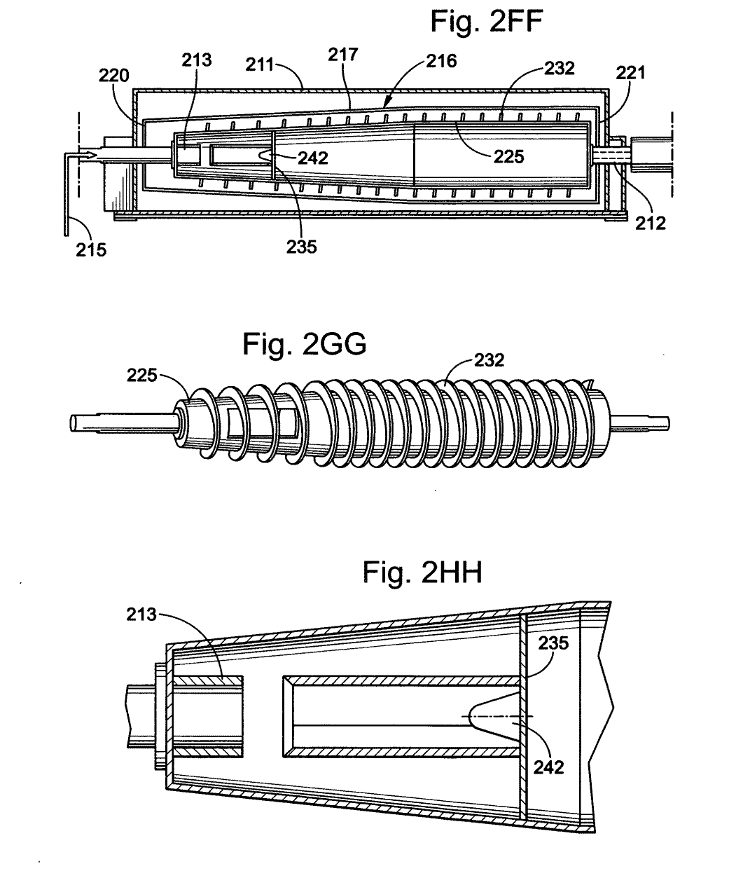

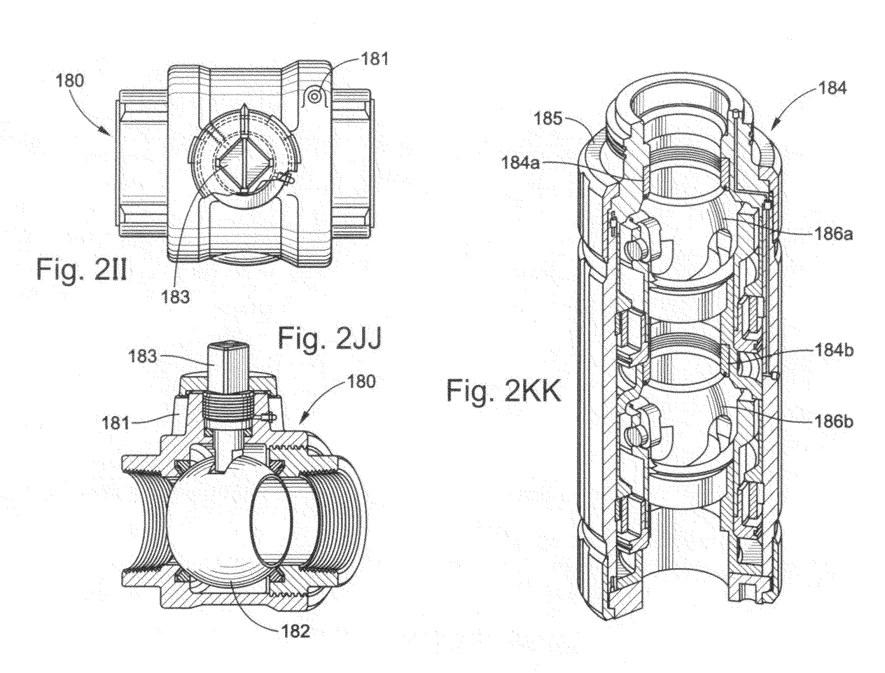

The mold 20 may be of any desirable shape and configuration to produce a finished article of any desirable shape and configuration. In addition to producing finished articles useful in armor, methods according to the present invention are useful for producing items, things, parts, insulators, tools and objects made, in whole or in part, with graphene ribbons as described above. FIGS. 2A-2Y and 2ZA-2KK present a variety of exemplary items, etc. made with ceramic material with graphene ribbon-like material according to the present invention. These depictions are not meant to be exhaustive of all the items, etc. that can be made with the material according to the present invention but are only presented here as some of the examples of such items, etc.

FIG. 2A shows a tile 102 made with ceramic material with transformed materials and/or graphene ribbons according to the present invention. This may be a tile for use in armor, in anti-ballistic structures, and on the space shuttle or other vehicles, air craft, or spacecraft.

FIG. 2B shows a disc 104 made with ceramic material with transformed materials and/or graphene ribbons according to the present invention.

FIG. 2C shows a panel 106 made with ceramic material with transformed materials and/or graphene ribbons according to the present invention.

FIG. 2D shows a cylinder 108 made with ceramic material with transformed materials and/or graphene ribbons according to the present invention.

FIG. 2E shows a pyramid 110 made with ceramic material with transformed materials and/or graphene ribbons according to the present invention.

FIG. 2F shows a sphere 112 made with ceramic material with transformed materials and/or graphene ribbons according to the present invention.

FIG. 2G shows a cone 111 made with ceramic material with transformed materials and/or graphene ribbons according to the present invention.

FIG. 2H shows a knife 114 made with ceramic material with transformed materials and/or graphene ribbons according to the present invention. A knife blade 113 and/or a handle 115 may be made from the material according to the present invention.

FIG. 2I shows a key 116 made with ceramic material with transformed materials and/or graphene ribbons according to the present invention.

FIG. 2J shows a gear 118 made with ceramic material with transformed materials and/or graphene ribbons according to the present invention.

FIG. 2K shows a hook 120 made with ceramic material with transformed materials and/or graphene ribbons according to the present invention.

FIG. 2L shows a nut-bolt combination 122 made with ceramic material with transformed materials and/or graphene ribbons according to the present invention with a bolt 119 and/or a nut 121 made with material according to the present invention.

FIG. 2M shows a chain 122 made with ceramic material with transformed materials and/or graphene ribbons according to the present invention.

FIG. 2N shows a chain 124 made with ceramic material with transformed materials and/or graphene ribbons according to the present invention.

Any known connector may be made with material according to the present invention (e.g., but not limited to, brads, nails, rivets, bolts, screws, and tacks). FIG. 2O shows a screw 126 made with ceramic material with transformed materials and/or graphene ribbons according to the present invention.

Surgical, dental, and orthodontic tools may be made, in whole or in part, with material according to the present invention.

FIG. 2P shows a scalpel 128 made with ceramic material with transformed materials and/or graphene ribbons according to the present invention.

FIG. 2Q shows a bearing structure 130 made with ceramic material with transformed materials and/or graphene ribbons according to the present invention with bearings 129 and/or bearing support 131 made with material according to the present invention.

It is within the scope of the present invention for all or part of a bit, mill or reamer to be made of material according to the present invention including, but not limited to, bit bodies, mill bodies, reamer bodies, cutting blades, milling blades, reaming blades, cutting surfaces, cutters, cutting inserts, milling surfaces, and/or reaming surfaces for bits, mills, and/or reamers for metal working, wood working, machining and/or for wellbore downhole drilling, milling and reaming.

FIG. 2R shows a drill bit 132 made with ceramic material with transformed materials and/or graphene ribbons according to the present invention.

FIG. 2S shows a mill 134 made with ceramic material with transformed materials and/or graphene ribbons according to the present invention.

FIG. 2T shows a reamer 136 made with ceramic material with transformed materials and/or graphene ribbons according to the present invention.

FIG. 2U shows a pipe 138 made with ceramic material with transformed materials and/or graphene ribbons according to the present invention. Optionally a threaded area 137 and/or a threaded area 139 is made with material according to the present invention.

FIG. 2V shows a universal joint 140 made with ceramic material with transformed materials and/or graphene ribbons according to the present invention.

FIG. 2W shows a drill bit 142 made with ceramic material with transformed materials and/or graphene ribbons according to the present invention with roller cones 141, bearings 143, 145 with body 147 and/or seal 149 made with material according to the present invention.

FIG. 2X shows a drill bit 150 made with ceramic material with transformed materials and/or graphene ribbons according to the present invention with a body 151, blades 153, and/or cutters (or cutting inserts) 155 made with material according to the present invention.

Hand tools, including, but not limited to wrenches, screw drivers, awls, chisels, hammers, saws, pliers, may be made, in whole or in part, with material according to the present invention.

FIG. 2Y shows pliers 160 made with ceramic material with transformed materials and/or graphene ribbons according to the present invention.

In any embodiment of the present invention which includes graphene ribbons, the graphene ribbons may, according to the present invention, be made by any known method.

The ceramic material in embodiments of the present invention may be any suitable known ceramic material, including, but not limited to, alumina, boron carbide, boron nitride, silicon carbide, titanium dioxide, zirconium dioxide, and transition metal dioxides.

In one aspect, in methods according to the present invention, the graphene ribbons that are produced are between 1 to 100 nanometers in width, between 500 nanometers and 10 microns in length and between 4 Angstroms and 2 nanometers thick.

Any article made according to the present invention can subsequently be cut, sanded, or machined as desired to produce an article of a particular size, shape, and/or configuration.

In certain embodiments, in an article according to the present invention, the ceramic density post-compression is between 90% to 99% by weight. In one aspect, it is 98%.

U.S. Pat. No. 6,420,293 discloses ceramic matrix nanocomposites containing carbon nanotubes and methods for making them. Unlike the present invention, U.S. Pat. No. 6,420,293 has no teaching or suggestion of using graphene or graphene ribbons in a ceramic article and no teaching or suggestion of methods for producing transformed materials and/or graphene ribbons in a ceramic mixture. The present invention provides various new and nonobvious improvements for the articles and the methods of U.S. Pat. No. 6,420,293 (which patent is incorporated fully herein for all purposes).

The present invention discloses, in certain aspects, a ceramic matrix composite which includes transformed materials and/or graphene ribbon material and nanocrystalline ceramic material (and/or ceramic powder), with or without other nanotube material and methods for producing ceramic articles with such material(s). The transformed materials or graphene ribbon material may be made during the process of making the ceramic matrix composite from nanotube material; or transformed materials and/or graphene ribbons may be mixed with ceramic material. The nanocrystalline ceramic material (or ceramic powder) may be a ceramic metal oxide. The metal of the ceramic metal oxide may be aluminum, titanium, zirconium, magnesium, yttrium, silicon, or cerium. In particular, the metal may be aluminum, titanium or zirconium. Specifically, the metal oxide may be alumina. In certain aspects, the amount of graphene ribbons in a finished article according to the present invention is 0.5 to 50 parts by volume; the amount of ceramic material is 50 to 99.5 parts by volume and, in one particular aspect, the amount of graphene ribbons may be 1 to 20 parts by volume, and the amount of ceramic material about 80 to 99 parts by volume.

In certain aspects, the present invention provides methods for producing ceramic articles including combining graphene ribbons and a ceramic matrix having at least one nanocrystalline ceramic material; forming an article therefrom; and heating, e.g., sintering, the article under elevated pressure and elevated temperature. Optionally, the graphene ribbons are made by crushing nanotube material which has been mixed with the ceramic material. The nanocrystalline ceramic material may be a ceramic metal oxide. The metal of the ceramic metal oxide may be aluminum, titanium, zirconium, magnesium, yttrium, or cerium. In particular, the metal may be aluminum, titanium or zirconium. In one aspect, the metal oxide is alumina. In certain aspects, the amount of graphene ribbons in the composite is about 0.5 to 50 parts by volume; the amount of ceramic matrix is about 50 to 99.5 parts by volume. In particular aspects, the amount of graphene ribbons is 1 to 20 parts by volume, and the amount of ceramic matrix about 80 to 99 parts by volume.

FIGS. 2Za and 2Zb show sluice 170 according to the present invention, e.g. for use in processing ores, dirt, material, etc., which has a trough 171 with holes 172. The trough 171 and/or side portions 173 may be made of material according to the present invention with ceramic and transformed materials and/or graphene nanoribbons.

FIGS. 2AA and 2BB show a ceramic wear plate 174 (e.g. of the type of U.S. Pat. No. D 591,779) made of material according to the present invention with ceramic and transformed materials and/or graphene nanoribbons. An optional top layer 175 of the wear plate 174 may also be made of material according to the present invention with ceramic and transformed materials and/or graphene nanoribbons.

FIG. 2CC shows a conveyor wear plate 176 according to the present invention made of material according to the present invention with ceramic and transformed materials and/or graphene nanoribbons (e.g. of the type of U.S. Pat. No. 5,419,4226).

FIG. 2DD shows a wear plate 178 for a pump (e.g. any known pump with such a wear plate, e.g., but not limited to, the pump of U.S. Pat. No. 6,599,086 and pumps disclosed in U.S. Pat. Nos. 3,754,834; 4,057,361; 4,527,948; 4,913,619; and 5,971,704). The plate 178 may be made of material according to the present invention with ceramic and transformed materials and/or graphene nanoribbons.

FIG. 2EE shows an impeller 179 according to the present invention made of material according to the present invention with ceramic and transformed materials and/or graphene nanoribbons (e.g. an impeller for use in a pump as in U.S. Pat. No. 7,037,069 or in any reference cited therein).

FIGS. 211 and 2JJ show a valve 180 according to the present invention which has a valve body 181, a movable valve member 182, and valve seats 180a, 180b. The member 182 is rotatable by a stem 183. The valve body 181, the valve member 182, and/or the stem 183 may be made according to the present invention with transformed nanotubes according to the present invention and/or with graphene nanoribbons.

FIG. 2KK shows a valve assembly 184 according to the present invention with a body 185; two valve members 186a, 186b pivotably mounted within the body 185; and valve seats 184a, 184b; the body 185; either or both valve members 186a, 186b; and/or the valve seats 184a, 184b may be, according to the present invention, made of transformed materials according to the present invention and/or with graphene ribbons.

FIGS. 2FF-2HH show a centrifuge 200 according to the present invention (e.g. of the type of centrifuge in U.S. Pat. Nos. 7,282,019; 7,001,324; 6,077,210; and 5,380,266) and parts thereof made of material according to the present invention with ceramic and transformed materials and/or graphene nanoribbons. Any part of the centrifuge 200 may be made of material according to the present invention, e.g., but not limited to, in inlet duct 215; an outer bowl 216 with a wall 217; a housing 211; a first end 220 and a second end 221; a rotor 225; a coupling 212; an auger 232; a plate 235; and a nose 242.

FIG. 3A is a scanning electron micrograph of an article A according to the present invention which has alumina material M with transformed material T according to the present invention. The article A was made from a matrix (see FIGS. 3G, 3H)of alumina L and carbon nanotubes N subjected to pressure (8000 psi) and temperature (1600 C. degrees) in an argon atmosphere for about 30 minutes.

FIGS. 3B-3F show a portion of the article A at various magnifications. The material T is dispersed throughout the article A.

The present invention, therefore, in at least certain embodiments, provides methods or making a ceramic article, the methods including: processing ceramic material producing processed ceramic material; processing carbon nanotube material producing processed nanotube material; combining the processed ceramic material and the processed nanotube material forming a first mixture; subjecting the first mixture to pressure converting the processed nanotube material to transformed material and heating the first mixture producing a processed article; and cooling the processed article, producing a finished ceramic article. Such a method may include one or some, in any possible combination, of the following: wherein the ceramic material is processed in a mill, the method further including milling the ceramic material producing pieces of a size between 10 nanometers and 100 microns, and having a surface area between 3.5 to 4.5 square meters per gram; wherein the ceramic material is one or a combination of alumina, boron carbide, boron nitride, silicon carbide, and metal oxides of titanium, zirconium, magnesium, yttrium, silicon, and cerium; the carbon nanotube material is one of or a combination of single-walled nanotubes, double-walled nanotubes, multi-walled nanotubes, and surface-modified nanotubes; wherein the transformed material is graphene ribbon-like material; wherein the graphene ribbon-like material is between 1 nanometer to 100 nanometers in width, between 500 nanometers and 10 microns long, and between 4 Angstroms and 2 nanometers thick; wherein the ceramic material is alumina and the carbon nanotube material is multi-walled nanotubes; wherein the first mixture is between 0.1% to 10% by weight carbon nanotube material; wherein the first mixture is between 0.1% to 1.0% by weight carbon nanotube material; wherein the pressure applied to the first mixture is between 10,000 psi and 100,000 psi and the heat is applied in a sintering apparatus in an inert oxygen free atmosphere; wherein the finished ceramic article has a ceramic density between 90% and 99%; wherein the finished ceramic article has a ceramic density of 98%; wherein the finished ceramic article is 0.5 to 50 parts by volume graphene ribbon-like material, and 50 to 99.5 parts by volume ceramic material; wherein the finished ceramic article is 1 to 20 parts by volume graphene ribbon-like material, and 80 to 99 parts by volume ceramic material; wherein the carbon nanotube material is processed by sonication in a solvent to deagglomerate the carbon nanotube material, to create a metastable nanotube suspension, and to wet surfaces of the carbon nanotube material with solvent; wherein ceramic material is mixed with a solvent and the first mixture is sonicated; wherein the finished ceramic article is one of tile, disc, panel, cylinder, pyramid, sphere, cone, knife, knife blade, knife handle, key, gear, hook, nut, bolt, chain, brad, nail, rivet, bolt, screw, tack, tool, scalpel, bearing structure, bearing, bit, mill, reamer, bit body, mill body, reamer body, cutting blade, milling blade, reaming blade, cutting surface, cutter, cutting insert, milling surface, reaming surface, pipe, pipe threaded area, universal joint, bit roller cone, bit bearing, bit seal, bit blade, hand tool, wrench, screw driver, awl, chisel, hammer, saw, pliers, sluice, wear plate, impeller, valve, valve body, valve member, valve seat, valve stem, centrifuge, centrifuge part, inlet duct, outer bowl, wall, housing, rotor, coupling, auger, and centrifuge nose; fashioning the finished ceramic article to produce a fashioned article; and/or wherein the fashioning is done by one of cutting, machining and sanding.

The present invention, therefore, in at least certain embodiments, provides methods for making a ceramic article, the methods including: processing ceramic material producing processed ceramic material; processing carbon nanotube material producing processed nanotube material; combining the processed ceramic material and the processed nanotube material forming a first mixture; subjecting the first mixture to pressure converting the processed nanotube material to transformed material and heating the first mixture producing a processed article, cooling the processed article, producing a finished ceramic article, wherein the transformed material is graphene ribbon-like material, wherein the graphene ribbon-like material is between 1 nanometer to 100 nanometers in width, between 500 nanometers and 10 microns long, and between 4 Angstroms and 2 nanometers thick, wherein the first mixture is between 0.1% to 1.0% by weight carbon nanotube material, and wherein the finished ceramic article has a ceramic density between 90% and 99%.

The present invention, therefore, provides a ceramic article made according to any method herein according to the present invention.

In conclusion, therefore, the present invention and the embodiments disclosed herein and those covered by the appended claims are well adapted to carry out the objectives and obtain the ends set forth. Certain changes can be made in the subject matter without departing from the spirit and the scope of this invention. It is realized that changes are possible within the scope of this invention and it is further intended that each element or step recited in any of the following claims is to be understood as referring to the step literally and/or to all equivalent elements or steps. The following claims are intended to cover the invention as broadly as legally possible in whatever form it may be utilized. The invention claimed herein is new and novel in accordance with 35 U.S.C. §102 and satisfies the conditions for patentability in §102. The invention claimed herein is not obvious in accordance with 35 U.S.C. §103 and satisfies the conditions for patentability in §103. This specification and the claims that follow are in accordance with the requirements of 35 U.S.C. §112. The inventors may rely on the Doctrine of Equivalents to determine and assess the scope of their invention and of the claims that follow as they may pertain to apparatus and/or methods not materially departing from, but outside of, the literal scope of the invention as set forth in the following claims. All patents and applications identified herein are incorporated fully herein for all purposes. It is the express intention of the applicant not to invoke 35 U.S.C. §112, paragraph 6 for any limitations of any of the claims herein, except for those in which the claim expressly uses the words ‘means for’ together with an associated function. In this patent document, the word “comprising” is used in its non-limiting sense to mean that items following the word are included, but items not specifically mentioned are not excluded. A reference to an element by the indefinite article “a” does not exclude the possibility that more than one of the element is present, unless the context clearly requires that there be one and only one of the elements.

What is claimed is:

1. A method for making a ceramic article, the method comprising
processing ceramic material producing processed ceramic material,
processing carbon nanotube material producing processed nanotube material,
combining the processed ceramic material and the processed nanotube material forming a first mixture,
subjecting the first mixture to pressure converting the processed nanotube material to transformed material and heating the first mixture producing a processed article, and
cooling the processed article, producing a finished ceramic article.

2. The method of claim 1 wherein the ceramic material is processed in a mill, the method further comprising milling the ceramic material producing pieces of a size between 10 nanometers and 100 microns, and having a surface area between 3.5 to 4.5 square meters per gram.

3. The method of claim 1 wherein the ceramic material is one or a combination of alumina, boron carbide, boron nitride, silicon carbide, and metal oxides of titanium, zirconium, magnesium, yttrium, silicon, and cerium.

4. The method of claim 1 wherein the carbon nanotube material is one of or a combination of single-walled nanotubes, double-walled nanotubes, multi-walled nanotubes, and surface-modified nanotubes.

5. The method of claim 1 wherein the transformed material is graphene ribbon-like material.

6. The method of claim 5 wherein the graphene ribbon-like material is between 1 nanometer to 100 nanometers in width, between 500 nanometers and 10 microns long, and between 4 Angstroms and 2 nanometers thick.

7. The method of claim 1 wherein the ceramic material is alumina and the carbon nanotube material is multi-walled nanotubes.

8. The method of claim 7 wherein the first mixture is between 0.1% to 10% by weight carbon nanotube material.

9. The method of claim 7 wherein the first mixture is between 0.1% to 1.0% by weight carbon nanotube material.

10. The method of claim 1 wherein the pressure applied to the first mixture is between 10,000 psi and 100,000 psi and the heat is applied in a sintering apparatus in an inert oxygen free atmosphere.

11. The method of claim 1 wherein the finished ceramic article has a ceramic density between 90% and 99%.

12. The method of claim 1 wherein the finished ceramic article has a ceramic density of 98%.

13. The method of claim 1 wherein the finished ceramic article is
0.5 to 50 parts by volume graphene ribbon-like material, and
50 to 99.5 parts by volume ceramic material.

14. The method of claim 1 wherein the finished ceramic article is
1 to 20 parts by volume graphene ribbon-like material, and
80 to 99 parts by volume ceramic material.

15. The method of claim 1 wherein the carbon nanotube material is processed by sonication in a solvent to deagglomerate the carbon nanotube material, to create a metastable nanotube suspension, and to wet surfaces of the carbon nanotube material with solvent.

16. The method of claim 15 wherein ceramic material is mixed with a solvent and the first mixture is sonicated.

17. The method of claim 1 wherein the finished ceramic article is one of tile, disc, panel, cylinder, pyramid, sphere, cone, knife, knife blade, knife handle, key, gear, hook, nut, bolt, chain, brad, nail, rivet, bolt, screw, tack, tool, scalpel, bearing structure, bearing, bit, mill, reamer, bit body, mill body, reamer body, cutting blade, milling blade, reaming blade, cutting surface, cutter, cutting insert, milling surface, reaming surface, pipe, pipe threaded area, universal joint, bit roller cone, bit bearing, bit seal, bit blade, hand tool, wrench, screw driver, awl, chisel, hammer, saw, pliers, sluice, wear plate, impeller, valve, valve body, valve member, valve seat, valve stem, centrifuge, centrifuge part, inlet duct, outer bowl, wall, housing, rotor, coupling, auger, and centrifuge nose.

18. The method of claim 1 further comprising
fashioning the finished ceramic article to produce a fashioned article.

19. The method of claim 18 wherein the fashioning is done by one of cutting, machining and sanding.

20. A method for making a ceramic article, the method comprising
processing ceramic material producing processed ceramic material,
processing carbon nanotube material producing processed nanotube material,
combining the processed ceramic material and the processed nanotube material forming a first mixture,
subjecting the first mixture to pressure converting the processed nanotube material to transformed material and heating the first mixture producing a processed article, cooling the processed article, producing a finished ceramic article,
wherein the transformed material is graphene ribbon-like material,
wherein the graphene ribbon-like material is between 1 nanometer to 100 nanometers in width, between 500 nanometers and 10 microns long, and between 4 Angstroms and 2 nanometers thick,
wherein the first mixture is between 0.1% to 1.0% by weight carbon nanotube material, and
wherein the finished ceramic article has a ceramic density between 90% and 99%.

21. A ceramic article made according to the method of claim 1.
